(19) United States
(12) Patent Application Publication
(10) Pub. No.: US 2015/0166372 A1
(43) Pub. Date: Jun. 18, 2015

(54) ELECTRODE MADE FROM XEROGEL SHEET COATED WITH SILICA FILM

(71) Applicant: University of Kentucky Research Foundation, Lexington, KY (US)

(72) Inventors: Xin Gao, Lexington, KY (US); James Landon, Lexington, KY (US); Kunlei Liu, Lexington, KY (US); Ayokunle Omosebi, Lexington, KY (US)

(73) Assignee: University of Kentucky Research Foundation, Lexington, KY (US)

(21) Appl. No.: 14/230,668

(22) Filed: Mar. 31, 2014

Related U.S. Application Data
(60) Provisional application No. 61/915,794, filed on Dec. 13, 2013.

(51) Int. Cl. C02F 1/469; B05D 3/02; B05D 1/18

(52) U.S. Cl. CPC C02F 1/4691; B05D 1/18; B05D 3/0272; C02F 2201/002; C02F 2201/46

(57) ABSTRACT

An electrode is provided which includes a xerogel sheet coated with a silica film. A method for producing the electrode includes steps of infiltrating a carbon cloth with a solution containing resorcinol and formaldehyde, polymerizing the solution infiltrated carbon cloth, subjecting the infiltrated and polymerized carbon cloth to a solvent-exchange process, carbonizing the carbon cloth and coating the carbonized carbon cloth with a silica film.

This utility patent application claims the benefit of priority in U.S. Provisional Patent Application Ser. No. 61/915,794 filed on Dec. 13, 2013, the entirety of the disclosure of which is incorporated herein by reference.

### TECHNICAL FIELD

This document relates generally to the field of conductive electrodes and, more particularly, to an electrode comprising a xerogel sheet coated with a silica film.

### BACKGROUND

Charge efficiency is one of the important performance terms for a capacitive deionization (CDI) cell, which is given by the ratio of the equivalent charge of salt adsorbed to the charge passed during the adsorption step. This efficiency value can be increased by variations in the applied voltage to the cell and the salt concentration, and the use of the membrane assisted electrodes. Beyond these physical variations/modifications, charge efficiency also can be alternatively elevated by chemically modifying the potential of zero charge (PZC) of carbons. If the electrode's PZC is located in the electrode's working domain, a charge inefficiency will occur due to co-ion repulsion.

The potential of zero charge (PZC) is the electrode potential for which the interfacial tension between the electrode and electrolyte is maximized, and the charge stored at the electrode is correspondingly minimized. In the literature, the region of the PZC for carbon xerogel (CX), carbon aerogel, and activated carbon has been observed in cyclic voltammograms (CV) when low scan rates and diluted salt solution were used. Additionally, the PZC formation mechanism depends on surface properties of the carbons. Since Si0₂ has a negative zeta potential in neutral solutions, TEOS-modification is shown here to affect the CX's surface polarity. As a consequence, a change in the PZC for the modified CX has been reflected in the CVs (see FIG. 4). By coating a xerogel material with a silica film coating we are able to provide an electrode for CDI cell applications which provides enhanced performance characteristics.

### SUMMARY

In accordance with the purposes and benefits described herein, an electrode is provided comprising a xerogel sheet coated with a silica film. The xerogel sheet comprises a conductive carbon cloth infiltrated with a solution containing resorcinol and formaldehyde. The silica film is formed from tetraethyl orthosilicate. The coating may have a thickness of between 10 Å and 100 nm.

In accordance with an additional aspect, a method is provided for making an electrode. That method comprises the steps of: (a) infiltrating a carbon cloth with a solution containing resorcinol and formaldehyde; (b) polymerizing the solution infiltrated onto the carbon cloth; (c) subjecting the polymerized carbon cloth to a solvent-exchange process; (d) carbonizing the carbon cloth; and (e) coating the carbonized carbon cloth with a silica film. In accordance with the method, the subjecting step may include serially soaking the infiltrated carbon cloth in deionized water and acetone followed by air drying. Further, the method may include completing the carbonizing at about 800-1100° C. for 30-360 minutes. In one embodiment the carbonizing is completed at about 1,000° C. for about 120 minutes using a ramp rate of about 1 to 5° C. per minute for heating from and cooling to room temperature. Further, the carbonizing includes using a nitrogen gas supply with flow greater than 300 ml/min during carbonizing in order to provide an inert atmosphere.

In one possible embodiment the solution used to infiltrate the carbon cloth has a mole ratio of resorcinol to formaldehyde of about 1:2. Further the coating step includes dipping the carbonized carbon cloth into a silica solution. That silica solution may include tetraethyl orthosilicate. In one embodiment the solution includes tetraethyl orthosilicate, ethanol and nitric acid with a volumetric ratio of 1:20:1. Still further the method may include (a) dipping the carbonized carbon cloth into the silica solution, (b) drying the carbonized carbon cloth following dipping and (c) repeating steps (a) and (b). The dipping may be done for three minutes followed by drying for thirty minutes. Further the method includes cutting the electrode to a desired shape.

These and other embodiments of the present invention will be set forth in the description which follows, and in part will become apparent to those of ordinary skill in the art by reference to the following description.

### BRIEF DESCRIPTION OF THE DRAWINGS

The accompanying drawings incorporated herein and forming a part of the specification, illustrate several aspects of the electrode made from a xerogel sheet coated with a silica film and together with the description serve to explain certain principles thereof. In the drawings:

FIG. 1 illustrates a xerogel sheet made from a carbon cloth infiltrated with a solution containing resorcinol and formaldehyde and subsequently polymerized, subjected to a solvent-exchange process and carbonized.

FIG. 2 illustrates the xerogel sheet of FIG. 1 following coating with a silica film.

FIG. 3 is FTIR spectra for carbon xerogel and silica-coated carbon xerogel materials as illustrated respectively in FIGS. 1 and 2.

FIG. 4 is a plot of the cyclic voltammograms (CV) for a carbon xerogel (CX) electrode and the new carbon xerogel electrode with the silica film coating.

FIGS. 5a and 5b are respective SEM images of an untreated carbon xerogel material and a carbon xerogel material with a silica film coating as taught in this document.

Reference will now be made in detail to the present electrode embodiments, examples of which are illustrated in the accompanying drawings.

### DETAILED DESCRIPTION

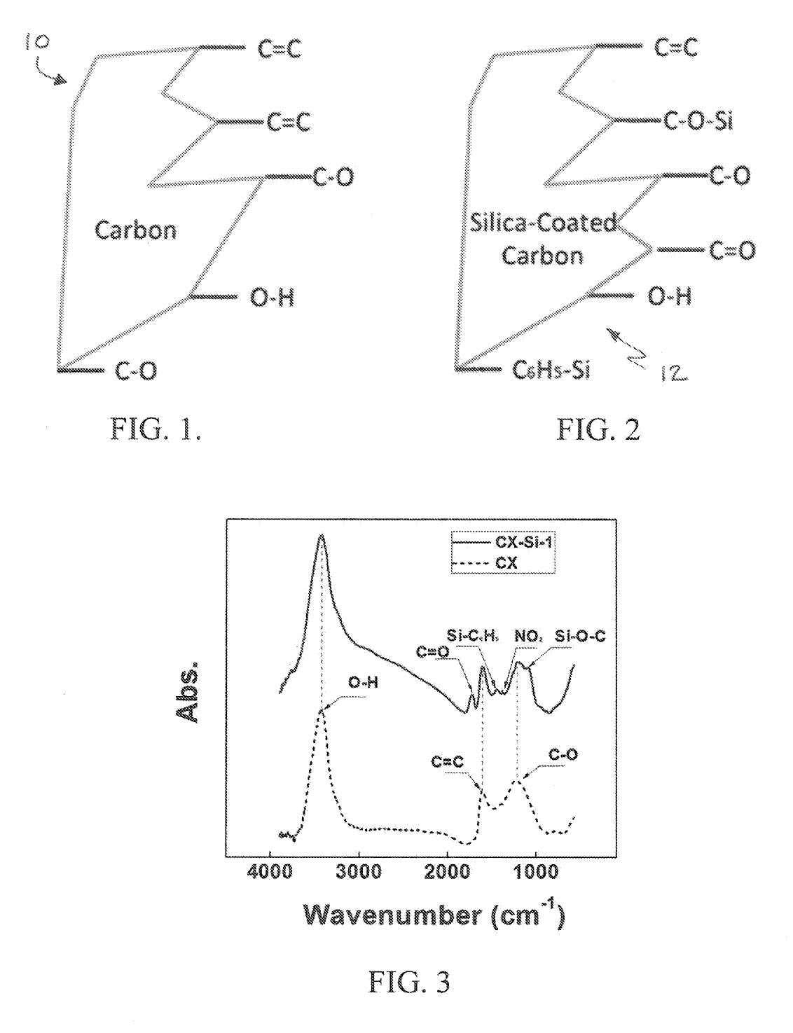

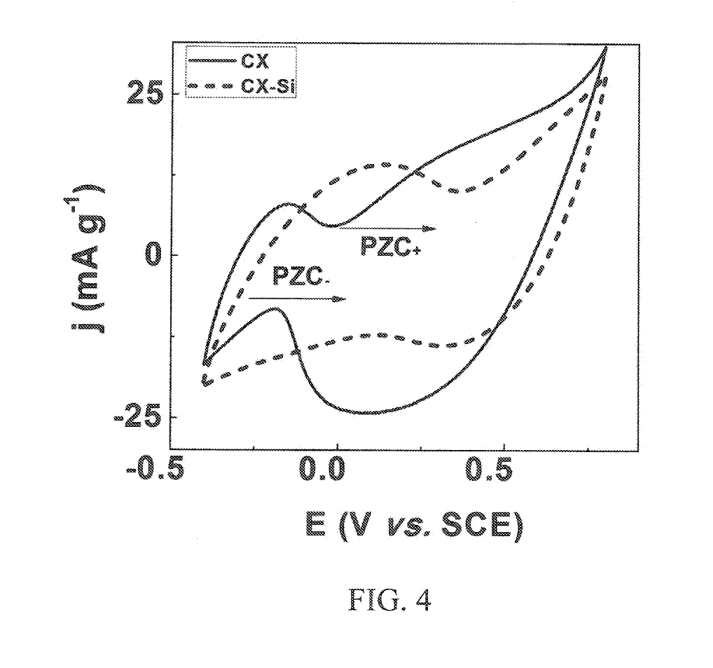

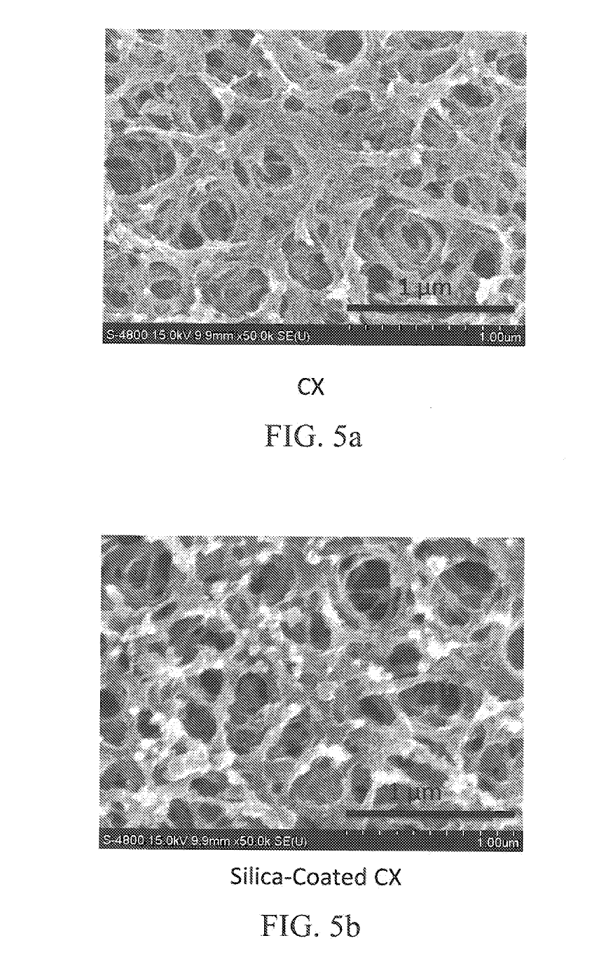

Reference is now made to FIG. 1 illustrating a xerogel sheet 10 which comprises a conductive carbon cloth infiltrated with a solution containing resorcinol and formaldehyde. In one embodiment that solution includes a mole ratio of resorcinol to formaldehyde of about 1:2. After infiltration the infiltrated cloth is subjected to polymerization. This is followed by subjecting the infiltrated carbon cloth to a solvent exchange process. That solvent exchange process includes serially soaking the infiltrated carbon cloth with deionized water and acetone. This is then followed by air drying.

Next the cloth is subjected to carbonizing. In one embodiment the carbonizing is completed at a temperature of between about 800 and about 1100° C. for between about 30 and about 360 minutes. In another embodiment the carbonizing is completed at about 1,000° C. for about 120 minutes. In any embodiment, the method may include using a ramp rate of about 1 to 5° C. per minute for heating from and cooling to room temperature. In one embodiment the carbonizing is completed in an inert atmosphere. In one embodiment the inert atmosphere is provided by using a nitrogen gas supply with flow greater than 300 ml/min during carbonizing. As illustrated in FIG. 1, the resulting carbonized xerogel sheet 10 has a surface chemistry including carbon carbon double bonds, carbon oxygen bonds and hydroxyl groups.

In accordance with an additional aspect of the present method, the carbonized xerogel sheet 10 is subjected to coating with a silica film. More specifically, the carbonized xerogel sheet 10 is dipped into a silica solution including tetraethyl orthosilicate (TEOS). In one embodiment the silica solution includes TEOS, ethanol and nitric acid with a volumetric ratio of 1:20:1. The pH of the solution is between about 2 pH and 8 pH. In one embodiment the method includes (a) dipping the carbonized carbon cloth into the silica solution, (b) drying the carbonized carbon cloth following dipping and (c) repeating steps (a) and (b) until the silica coating is provided at a desired thickness. In one embodiment that thickness is between 10 Å-10 nm. In another embodiment that thickness is between 10 nm-100 nm.

To achieve this end the dipping may be for three minutes followed by drying for thirty minutes. The dried silica film coated xerogel sheet forms an electrode 12 (see FIG. 2) including a unique surface chemistry. As illustrated in FIG. 2, that surface chemistry includes —Si and —COOH functional groups which increase the negative charge on the surface of the electrode. This promotes cation absorption and thereby increases the wettability of the electrode 12 to provide for enhanced performance. This is particularly true for an electrode 12 utilized in capacitive deionization applications such as for the purification of salt water into drinking water.

Reference is made to the following example which further illustrates the electrode and the method of making the same.

### Preparation of Silica-Coated Carbon Xerogel Sheets

The fabrication of silica-coated carbon xerogel (CX) sheets consisted of two steps—1) preparation of the CX sheet and 2) dip-coating of the resulting CX sheet within TEOS mixtures. In the following paragraphs, these steps will be detailed.

The CX sheets were composed of commercially conductive carbon cloth (untreated, Fuel Cell Store) infiltrated with solutions mainly containing resorcinol (Sigma-Aldrich), and formaldehyde (37 wt % in methanol, Sigma-Aldrich) mixed in a 1:2 mole ratio. The detailed preparation of the solution will be introduced separately. After infiltration, the wet substrates were immobilized between two glass slides and sealed overnight. The sheets were then heated at 85° C. for a period of 24 hours in air, where the polymerization reaction was halted under such conditions. Subsequently, a solvent-exchange process was performed for the polymerized samples, in which the samples were subjected to 2-hours of soaking in deionized water, 2-hours of soaking in acetone, and 2-hours of air-drying. Finally, the samples were carbonized at 1000° C. for 2 hours using a ramp rate of 1 or 5° C. per minute for both heating and cooling from room temperature using a nitrogen gas supply with flow greater than 300 ml/min. The quartz tube used here was 48 inches long with an external diameter of 3 inches and an internal diameter of 2.75 inches.

Following fabrication of the CX sheets, the CX sheets were modified by the following steps in order to lead to a silica film being formed at the carbon surface: TEOS (Sigma-Aldrich), ethanol (Pharmco-Aaper), and HNO₃ (Acros) were vigorously mixed with a volumetric ratio of 1:20:1 in a sealed glass bottle for 1 hour at room temperature. The CX sheets were dipped into the mixture for 3 min, and dried in an oven at 100° C. for 30 min. The CX sheets were dipped repetitively into the TEOS mixture so as to vary the amount of silica deposited. All the received CX sheets were kept in a vacuum desiccator before any characterization.

FTIR spectroscopy examined the chemical species at the CX surface (FIG. 3). By comparison, new bands at ˜1730, ˜1430 and ˜1100 cm⁻¹ corresponding to C═O stretching, Si—C₆H₅ stretching, and Si—O—C stretching, respectively were found (dashed and solid line). This assignment indicates that the modification resulted not only in a thin-film containing Si, but also in the attachment of —COOH functional groups to the carbon surface. This change is schematically illustrated in FIGS. 1 and 2. The addition of these —Si and —COOH functional groups increased the negative charge on the carbon surface (promoting cation adsorption) and increased the wettability of the carbon.

Preparation of Carbon Xerogel Sheets with Different Porosities and Surface Areas

### Effect of Na₂CO₃ Concentration on Porosities and Surface Areas

The solutions were prepared by mixing 10 g resorcinol, 14.74 g formaldehyde (37 wt % in methanol), 3 g of X M Na₂CO₃ solution (where X=0.01, 0.02, 0.1, 0.25, and 0.5) in a sealed glass bottle. These chemical agents were vigorously mixed for 0.5 hours at room temperature. The resulting solutions were subsequently examined using a pH meter. As expected, we found that the pH of the solutions were strongly affected using the Na₂CO₃ solutions with different concentrations. The corresponding results are listed in Table 1 (see below). It can be seen that an increase in the concentration of Na₂CO₃ solutions results in an increase in the pH of the solutions.

TABLE 1
Effect of Na₂CO₃ addition on pH of mixtures. In this study,
the mass of resorcinol and formaldehyde (37 wt % in methanol)
is fixed at 10 g and 14.74 g, respectively, resulting in the mole ratio
of resorcinol and formaldehyde being 1:2. Following this mixing, 3 g of
X M Na₂CO₃ solution was added, where X = 0.01, 0.02,
0.1, 0.25 and 0.5.

| X (concentration of Na₂CO₃)/M | pH |
|---|---|
| 0.01 | 2.62 |
| 0.02 | 4.55 |
| 0.1 | 6.62 |
| 0.25 | 7.17 |
| 0.5 | 7.58 |

The use of the same CX preparation procedure but solutions with different pH values yielded different isotherms measured by a porosity and surface area analyzer (Micrometrics, ASAP 2020). Based upon the isotherms, the corresponding pore volumes and surface areas were calculated using the BJH method and BET method, respectively, and the corresponding results can be seen in Table 2 (see below). It was found that the addition of Na₂CO₃ with different concentrations (the adjustment of solution's pH) has affected the porosities and surface areas of the resulting CX sheets. In general, an increase in the Na₂CO₃ concentration leads to a decrease in the pore volume but an increase in the surface area.

TABLE 2
Effect of Na₂CO₃ addition on CX sheets' porosities
and surface area. The porosities and surface areas were
calculated using BJH method based upon desorption isotherms.

| | Pore Volume | Surface Area |
|---|---|---|
| X (concentration of Na₂CO₃) (M) | (cm³ g⁻¹) | (m² g⁻¹) |
| 0.01 | 0.57 | 150.11 |
| 0.02 | 0.40 | 171.31 |
| 0.1 | 0.26 | 211.36 |
| 0.25 | 0.15 | 203.79 |
| 0.5 | 0.047 | 106.9 |

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An electrode, comprising a xerogel sheet coated with a silica film.

2. The electrode of claim 1, wherein said xerogel sheet comprises a conductive carbon cloth infiltrated with a solution containing resorcinol and formaldehyde.

3. The electrode of claim 2, wherein said silica film is formed from tetraethyl orthosilicate.

4. The electrode of claim 1, wherein said coating has a thickness of between 10 Å and 100 nm.

5. A method of making an electrode, comprising:
infiltrating a carbon cloth with a solution containing resorcinol and formaldehyde;
polymerizing said solution infiltrated carbon cloth;
subjecting said polymerized carbon cloth to a solvent-exchange process;
carbonizing said polymerized carbon cloth; and
coating said carbonized carbon cloth with a silica film.

6. The method of claim 5, wherein said subjecting step includes:
serially soaking said infiltrated carbon cloth in deionized water and acetone; and
air drying.

7. The method of claim 6, including completing said carbonizing at about 800-1100° C. for 30-360 minutes.

8. The method of claim 7 including using a ramp rate of about 1° C. to 5° C. per minute for heating from and cooling to room temperature.

9. The method of claim 8, including using a nitrogen gas supply with a flow rate greater than 300 ml/min to provide an inert atmosphere during carbonizing.

10. The method of claim 6, including completing said carbonizing at about 1,000° C. for about 120 minutes.

11. The method of claim 10, including using a ramp rate of about 1 to 5° C. per minute for heating from and cooling to room temperature.

12. The method of claim 11, including using a nitrogen gas supply with flow greater than 300 ml/min to provide an inert atmosphere during carbonizing.

13. The method of claim 5, including using a mole ratio of resorcinol to formaldehyde of about 1:2.

14. The method of claim 5, wherein said coating includes dipping said carbonized carbon cloth into a silica solution.

15. The method of claim 14, including using a silica solution including tetraethyl orthosilicate.

16. The method of claim 14, including using a silica solution including tetraethyl orthosilicate, ethanol and nitric acid with a volumetric ratio of 1:20:1.

17. The method of claim 16, including (a) dipping said carbonized carbon cloth into said silica solution, (b) drying said carbonized carbon cloth following dipping and (c) repeating steps (a) and (b).

18. The method of claim 17, further including dipping for three minutes and drying for thirty minutes.

19. The method of claim 5, further including cutting said electrode to a desired shape.

20. The method of claim 5, including altering concentration of Na₂CO₃ in said solution of resorcinol and formaldehyde to control porosity and surface area of resulting electrode.
